(19) United States
(12) Patent Application Publication
(10) Pub. No.: US 2008/0261139 A1
(43) Pub. Date: Oct. 23, 2008

(54) Electrophotographic Toner

(76) Inventors: Bernd Schultheis, Schwabenheim (DE); Holger Kobrich, Kraichtal (DE); Detlef Helmut Josef Rehorek, Scheulder (NL)

Correspondence Address: PAULEY PETERSEN & ERICKSON, 2800 WEST HIGGINS ROAD, SUITE 365, HOFFMAN ESTATES, IL, 60195, US

(21) Appl. No.: 11/667,251

(22) PCT Filed: Oct. 18, 2005
(86) PCT No.: PCT/EP2005/011180

§ 371 Date: Jan. 18, 2008

(30) Foreign Application Priority Data
Nov. 8, 2004 (DE) 10 2004 054 132.9

(51) Int. Cl. G03G 9/08

(52) U.S. Cl. 430/108.7

(57) ABSTRACT

The invention relates to an electrophotographic toner comprising toner particles (10), which contain a matrix material (11), at least part of said toner particles (10) having a first glass flow component (13) with a first melting temperature. The aim of the invention is to create translucent surfaces on glass substrates in a simple manner. To achieve this at least part of the toner particles has an additional second glass flow component, whose melting temperature is greater than the first glass flow component.

The invention relates to an electrophotographic toner with toner particles, which have a matrix material, characterized in that the toner particles have, at least partly, a first glass flux component, possessing a first melting point.

Such a toner is known from WO 03/058351 A1, in which a ceramic toner is described, which has a glass flux as constituent. The glass flux is such that the toner is suitable for printing on special glasses, for example glass ceramics.

Glass objects that have a roughened surface are also known from the state of the art. This is formed for example by sandblasting or by etching. This surface then offers a particular optical effect. Instead of mechanical processing of the surface, screen printing processes are sometimes also used, in which an ink is knife-coated on the surface of the glass substrate. After hardening/baking, the ink forms a layer on the glass, creating the impression of a processed glass surface. In the screen printing process, for each decorative effect it is necessary to produce a corresponding screen, so that individual printing cannot be carried out directly.

The problem of the invention is to make available a toner of the type mentioned previously, with which a translucent structure can be produced on a glass surface in a simple manner.

This problem is solved in that at least a proportion of the toner particles have an additional second glass flux component, which has a higher melting point than the first glass flux component, or in that a further proportion of the toner particles have a second glass flux component, which has a higher melting point than the first glass flux component.

The difference in melting points of the two glass flux components means that the low-melting glass flux component is largely fused-on during baking. The glass flux component with the higher melting point is bound to the glass substrate through the medium of the first, fused-on glass flux component. It melts incompletely, or not at all. Then in the transition region between the fused-on and the non-fused glass flux component there is formation of optical transitions, where the light is refracted. The non-fused or partially-fused glass flux particles thus form light-scattering centers. Therefore, with the toner according to the invention, translucent layers can be produced individually on the surface of the glass substrate in a simple manner.

The problem of the invention is also solved in that the toner particles have, at least partly, a first glass flux component that has a first melting point, with the glass flux particles of the first glass flux component having a first size distribution and the glass flux particles of the second glass flux component having a second size distribution and with the size distribution of the first glass flux component having a smaller average size than that of the second size distribution. In this embodiment, the previously mentioned light-scattering centers are generated by means of a controlled fusing process. Advantage is taken of the fact that small glass flux particles are as a rule fused faster than the larger ones. With suitable control of process temperature and time, the “large” glass flux portions do not melt completely. This means that the glass flux components can even consist of the same material.

Preferably, a bimodal size distribution is provided for the composition of the glass flux component.

According to a preferred embodiment of the invention, the glass flux components are based on glasses that do not contain heavy metals, in particular Pb-free and/or Cd-free glasses. The toner is therefore free from substances that pollute the environment. This is also advantageous from workplace safety requirements.

It can be envisaged that the glass flux components are based on zinc-borosilicate glass. This glass flux is available as an inexpensive starting material, which is most suitable for documentation especially in the coating of glass ceramics and prestressed special glasses.

If a colored sandblasted, imitation etching or similar decorative effect is to be created, according to the invention at least one of the glass flux components can comprise a tinted glass. The glass flux can then contain finely-divided metals, for example as nanoparticles or coloring metal ions.

It is preferable for the first glass flux component to have a melting point >500° C. and the second glass flux component a melting point >550° C., and in particular for the first glass flux component to have a melting point in the range from 600 to 650° C. and the second glass flux component in the range from 650 to 700° C. Depending on burn-out control, the difference between the two melting points can be selected to avoid complete fusion of the second glass flux component with sufficient certainty.

With the toners according to the invention, it is important to use a matrix material that does not have an adverse effect on the optical properties of the toner pattern produced. In particular it is necessary to ensure that the fusing-on of the glass flux components is not hampered during burning of the matrix material.

For this reason it is possible for the matrix material to be formed from a polymer matrix, for the polymer matrix to have a polyester and/or styrene acrylate and for the proportion of the polyester to be 5-100 wt. % of the polymer matrix. These polymer matrixes have the advantage that they burn out over a wide temperature range (for example in the range from 350 to 500° C.). This definitely has a beneficial effect on the uniformity of the printed pattern. Pinholes, for example caused by burn-out being too fast, are largely prevented by this polymer matrix. The polymer toners burn out completely or almost completely, without leaving behind unwanted residues. This is achieved particularly effectively with toners for which the composition range of the polymer matrix for the components polyester/styrene acrylate is in the range from 50/50 to 20/80 wt. %. The continuous burn-out behavior of the toner beyond a wide temperature range can then be supported in a simple manner, if it is provided that the styrene acrylate fraction in the polymer matrix has at least two styrene acrylate components, having different melting ranges.

The invention will be explained in more detail below, based on an example of application depicted in the drawings, which show:

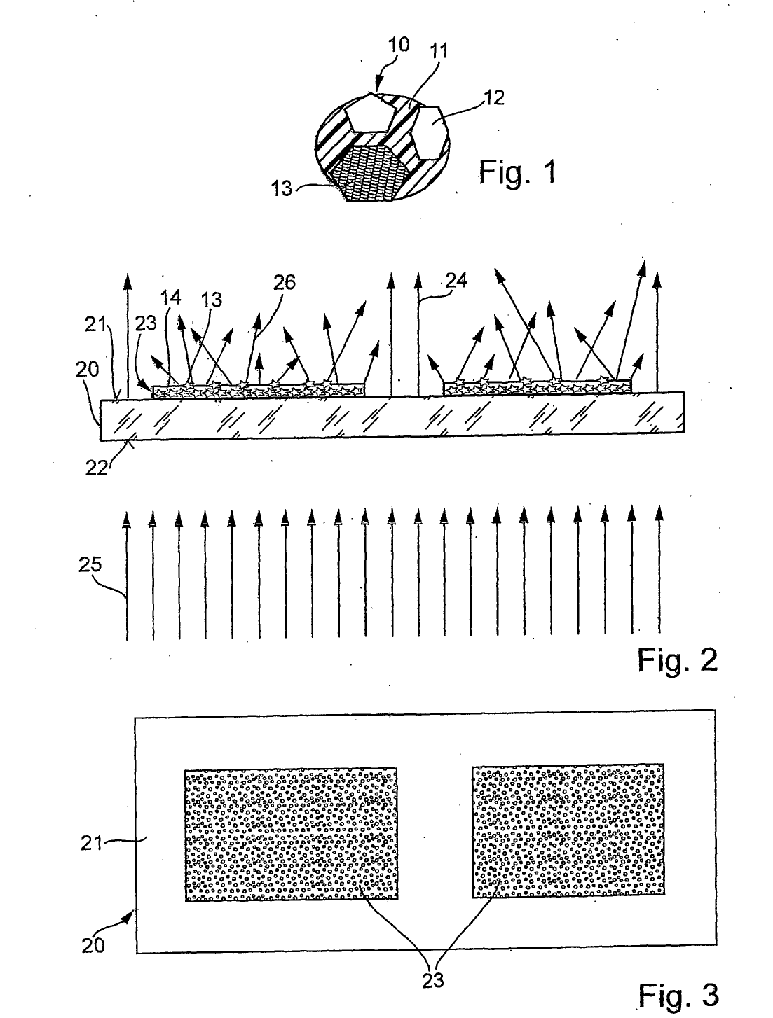

FIG. 1 in schematic cross-section, a toner particle of a toner according to the invention,

FIG. 2 a lateral sectional view of a glass plate coated with a toner pattern

FIG. 3 the front view of the glass plate according to FIG. 2

FIG. 1 is a schematic representation of a toner particle 10, as used in a single-component or two-component toner. The toner particle 10 has material matrix 11. As a rule this comprises a polymer material, which for example contains the constituents polyester and styrene acrylate. A first and a second glass flux component 12 and 13 are embedded in the matrix material 11. The first glass flux component 12 has a lower melting point than the second glass flux component 13.

The toner particles of a toner are either all or only partially constructed in the manner shown in FIG. 1. It is also conceivable for another portion of the toner particles 10 to have just one of the two glass flux components.

The toner can be applied to a glass substrate 20 by means of an electrophotographic printing process. Such a printing process is for example described sufficiently in DE 103 36 352. The contents of this document are incorporated in the present specification in this respect.

After the toner has been printed onto the surface of the glass substrate, it is baked on under the action of heat. The baking temperature is selected to be above the melting point of the first glass flux component 12, but below that of the second glass flux component 13. As a result, the first glass flux component 12 melts completely, and forms the fused-on glass flux 14, as labeled correspondingly in FIG. 2. The second glass flux component 13 does not melt (or at any rate not completely) and thus forms light-scattering centers. The fused-on glass flux thus acts as an adhesion promoter between the glass substrate 20 and the second glass flux component 13. In this way, the print 23 is produced as toner pattern on the front 21 of the glass substrate 20. The matrix material 11 burns out without residue during baking of the toner.

As can also be seen in FIG. 2, light 25 is led into the glass substrate 20, for example from the back 22. The light enters the fused-on glass flux 14. Preferably the latter has the same refractive index as the glass substrate 20. The light 25 is refracted in the region of the particles of the second glass flux component 13 serving as light-scattering centers, thus producing the scattered light 26. In this way, the print 23 provides a coating that creates a translucent glass object. In addition to charge control substances, the toner can also contain flow auxiliaries for improved flow behavior during baking. The glass flux components 12, 13 are as a rule not embedded completely in the matrix material, but are only partially enveloped by it.

The glass flux components 12, 13 can, as shown in FIG. 1, be present in a toner particle as separate particles. It is also conceivable for particles containing both glass flux components to be used.

The fraction of the glass flux components in the toner is >50 wt. % to 80 wt. %, typically 60 to 75 wt. % and preferably <70 wt. %.

For ideal transfer of toner to the glass substrate, the particle size of the toner particles is selected so that the D 50 vol value is between 5 and 15 μm.

The size of the glass flux particles is preferably D 50 vol_{—}9 to 10 μm and/or the D 90 vol value is in the range <15 μm, preferably _{—}10 μm.

Glasses, such as soda-lime glasses, borosilicate glasses, transparent, tinted or non-colored glass ceramics (for example Li—Al—Si glass ceramics), having a high quartz mixed-crystal phase, are suitable for printing-on.

In the case of soda-lime glasses the toner can be baked even during the prestressing process (600-720° C.), preferably in the range from 600 to 650° C., or in the case of glass ceramics during the ceramization process (up to 900° C.). Subsequent baking (secondary firing) is of course also possible. The toner is transferred in the electrophotographic printing process. Individual structuring of the pattern is then possible. For flat printing, electrostatic printing can also be carried out.

A sufficiently translucent effect can be achieved with layer thicknesses in the range from 1 to 15 μm, typically from 3 to 5 μm.

Possible applications are printed glass doors, architectural glass, shower cubicle doors, shower cubicles, glass screens, glass containers, glass ceramics, for example see-through oven doors, ceramic hobs etc.

1. An electrophotographic toner with toner particles (10) having a matrix material (11), with the toner particles (10) having at least partially a first glass flux component (13), which has a first melting point, characterized in that at least a portion of the toner particles (10) have an additional second glass flux component (12), with melting point higher than that of the first glass flux component.

2. An electrophotographic toner with toner particles (10) having a matrix material (11), with the toner particles (10) having a first glass flux component (13), having a first melting point, characterized in that a further proportion of the toner particles (10) has a second glass flux component (12), the melting point of which is higher than that of the first glass flux component (12).

3. An electrophotographic toner with toner particles (10), having a matrix material (11), with the toner particles (10) having at least partially a first glass flux component (13), possessing a first melting point, where the glass flux particles of the first glass flux component (12) have a first size distribution and the glass flux particles of the second glass flux component (13) have a second size distribution and where the size distribution of the first glass flux component has a smaller average size than that of the second size distribution.

4-17. (canceled)
